(19) United States
(12) Patent Application Publication
(10) Pub. No.: US 2020/0407246 A1
(43) Pub. Date: Dec. 31, 2020

(54) Electrochemical Removal of Arsenic Using An Air Diffusion Cathode

(71) Applicants: The Regents of the University of California, Oakland, CA (US); Universiteit Utrecht Holding B.V., Utrecht (NL)

(72) Inventors: Ashok GADGIL, El Cerrito, CA (US); Siva Rama Satyam BANDARU, Berkeley, CA (US); Case VAN GENUCHTEN, De Bilt (NL)

(21) Appl. No.: 16/976,705

(22) PCT Filed: Mar. 4, 2019
(86) PCT No.: PCT/US2019/020580

§ 371 Date: Aug. 28, 2020

Related U.S. Application Data
(60) Provisional application No. 62/637,875, filed on Mar. 2, 2018.

(51) Int. Cl. C02F 1/463; C02F 1/467

(52) U.S. Cl. CPC C02F 1/463; C02F 2001/46166; C02F 1/4672

(57) ABSTRACT

The present invention provides methods for removing arsenic from an aqueous solution containing dissolved arsenic using a continuous-flow air-cathode iron electrocoagulation device and current densities of from at least 30 mA·cm⁻² to about 250 mA·cm⁻². The present invention also provides continuous-flow air-cathode iron electrocoagulation devices having barriers for reducing electrode fouling and maintaining faradaic efficiency for longer periods of time.

### CROSS-REFERENCES TO RELATED APPLICATIONS

The present application claims priority to U.S. Provisional Pat. Appl. No. 62/637,875, filed on Mar. 2, 2018, the entire content of which is incorporated in its entirety herein for all purposes.

### STATEMENT AS TO RIGHTS TO INVENTIONS MADE UNDER FEDERALLY SPONSORED RESEARCH AND DEVELOPMENT

This invention was made with government support under Contract No. DE-AC02-05CH11231 awarded by the U.S. Department of Energy. The government has certain rights in the invention.

### BACKGROUND OF THE INVENTION

At the maximum contaminant limit (MCL) permitted by the Environmental Protection Agency (EPA) in drinking water for various carcinogens, arsenic causes the most cancers. Arsenic causes more cancers than cancers from all other permitted carcinogens combined at their MCLs. In California, many poor, rural communities, especially in the Central Valley, must rely for their drinking water supply on groundwater contaminated with arsenic at concentrations higher than its EPA MCL.

### BRIEF SUMMARY OF THE INVENTION

Described herein is a robust, low cost technology that reliably removes arsenic to below EPA's MCL (10 ppb). In particular, provided herein are devices and methods related to the improved operation of a continuous-flow air-cathode iron electrocoagulation device. Improvements include decreased arsenic removal time using smaller reactor cell sizes (e.g., increased flow rates, higher throughput), lower demands for electrode cleaning, and higher faradaic efficiency for long term operation times. Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

In one aspect, the present invention provides a method for removing arsenic from an aqueous solution comprising dissolved arsenic. The method involves flowing the aqueous solution through a continuous-flow air-cathode iron electrocoagulation device having at least one reactor cell, wherein the at least one reactor cell comprises: a housing having at least one inlet, at least one outlet, at least one anode comprising iron, and at least one air-cathode, wherein inflowing aqueous solution enters the reactor cell through the at least one inlet and outflowing aqueous solution exits the reactor cell through the at least one outlet; running a direct current through the aqueous solution via the anode and cathode at a voltage sufficient to produce a current density of from at least 30 mA·cm⁻² to about 250 mA·cm⁻²; and forming iron(II) species from the iron of the anode and forming H₂O₂ from the oxygen diffusion of the air-cathode, thereby producing insoluble iron(III) species comprising iron(III) hydroxides and arsenic-containing iron(III)-hydroxide precipitates, thereby removing arsenic from the aqueous solution, wherein the outflowing aqueous solution has a reduction in dissolved arsenic compared to the inflowing aqueous solution. In some embodiments, the method further comprises physically removing the insoluble iron(III) species comprising iron(III) hydroxides and arsenic-containing iron(III)-hydroxide precipitates from the outflowing aqueous solution.

In some embodiments, the current density is from about 50 mA·cm⁻² to about 200 mA·cm⁻², from about 60 mA·cm⁻² to about 150 mA·cm⁻², from about 75 mA·cm⁻² to about 125 mA·cm⁻², or from about 85 mA·cm⁻² to about 110 mA·cm⁻².

In some embodiments, the anode comprises iron in an amount of from about 80% about 99.9%. In some embodiments, the anode comprises low carbon steel, iron-aluminum alloy, or pure iron.

In some embodiments, the air-cathode comprises a current collector selected from stainless steel mesh, titanium mesh, conducting polymer mesh, or foamed nickel; a catalytic layer selected from graphite, carbon black, carbon fiber, carbon cloth, carbon paper, nitrogen-doped carbon, activated carbon, or a combination thereof; and a diffusion layer selected from polyvinylidene fluoride (PVDF), polytetrafluoroethylene (PTFE), or polydimethylsiloxane (PDMS).

In some embodiments, the anode and the air-cathode are positioned at an inter-electrode distance of from at least 0.2 cm to about 5.0 cm, from about 0.5 cm to about 3.0 cm, or from about 1.0 cm to about 2.5 cm. In some embodiments, the anode and the air-cathode have surface areas of from about 1.0 cm² to about 5.0 m² or from about 5.0 cm² to about 800 cm².

In some embodiments, the at least one reactor cell of the continuous-flow air-cathode iron electrocoagulation device is from at least 1.0 cm² to about 5.0 m², from about 5.0 cm² to about 1.0 m², or from about 10.0 cm² to about 1.0 m². In some embodiments, the at least one reactor cell has a volume of from about 0.1 L to about 200 L, from about 0.5 L to about 100 L, from about 0.8 L to about 5.0 L, or from about 1.5 L to about 2.5 L.

In some embodiments, the continuous-flow air-cathode iron electrocoagulation device comprises a plurality of reactor cells. In some embodiments, the continuous-flow air-cathode iron electrocoagulation device comprises from 2 to 50 reactor cells or 10-20 reactor cells. In some embodiments, each reactor cell of a continuous-flow air-cathode iron electrocoagulation device comprising a plurality of reactor cells (e.g., 2-50, 10-20) is stacked on top of each other.

In some embodiments, the outflowing aqueous solution has a reduction in dissolved arsenic of at least 95% compared to the inflowing aqueous solution.

In some embodiments, the aqueous solution continuously flows through the continuous-flow air-cathode iron electrocoagulation device at a dosage rate of from about 50 C/L/min to about 8000 C/L/min or from about 80 C/L/min to about 600 C/L/min.

In some embodiments, the at least one reactor cell of the continuous-flow air-cathode electrocoagulation device further comprises a bisecting perforated barrier disposed between the anode and the air-cathode. In some embodiments, the bisecting perforated barrier is disposed longitudinally between the anode and the air-cathode. In some embodiments, the bisecting perforated barrier is disposed diagonally between the anode and the air-cathode. In some embodiments, the aqueous solution enters the at least one reactor cell through the at least one inlet and flows across the perforated barrier. In some embodiments, the at least one anode and the at least one air-cathode are in a staggered position relative to each other. In some embodiments, the at least one anode and the at least one air-cathode are in a staggered position relative to each other and the at least one reactor cell of the continuous flow air cathode electrocoagulation device further comprises a bisecting barrier perpendicularly disposed between the anode and the air-cathode, wherein the barrier comprises at least one hole.

In some embodiments, the aqueous solution flows through the continuous-flow air-cathode iron electrocoagulation device for about 40 hours to about 1000 hours, or about 90 hours to about 500 hours. In some embodiments, wherein the continuous-flow air-cathode iron electrocoagulation device maintains at least 50% faradaic efficiency of H₂O₂ production after at least about 50 hours of continuous flow.

Another aspect of the present invention relates to a continuous-flow air-cathode iron electrocoagulation device having at least one reactor cell, wherein the at least one reactor cell comprises: a housing having at least one inlet for an aqueous solution comprising an amount of dissolved arsenic and at least one outlet for the aqueous solution having a reduced amount of dissolved arsenic; at least one air-cathode disposed within the housing and at least one anode comprising iron disposed within the housing, wherein the cathode and anode are laterally aligned with respect to each other and disposed on opposing sides of the housing; a bisecting perforated barrier disposed within the house between the cathode and anode, wherein the bisecting perforated barrier reduces contact between the cathode and insoluble iron(III) species comprising iron(III) hydroxides and arsenic-containing iron(III)-hydroxide precipitates; and a direct power source; and wherein the at least one inlet allows for flow of the aqueous solution comprising an amount of dissolved arsenic across the perforated barrier. In some embodiments, the bisecting perforated barrier is disposed longitudinally between the anode and the air-cathode. In some embodiments, the bisecting perforated barrier is disposed diagonally between the anode and the air-cathode.

In another aspect, the present invention relates to a continuous-flow air-cathode iron electrocoagulation device having at least one reactor cell, wherein the at least one reactor cell comprises: a housing having at least one inlet for an aqueous solution comprising an amount of dissolved arsenic and at least one outlet for the aqueous solution having a reduced amount of dissolved arsenic; at least one air-cathode disposed within the housing and at least one anode comprising iron disposed within the housing, wherein the cathode and anode are laterally staggered with respect to each other and disposed on opposing sides of the housing; a direct power source; and wherein the lateral staggering of the cathode and anode reduces contact between the cathode and insoluble iron(III) species comprising iron(III) hydroxides and arsenic-containing iron(III)-hydroxide precipitates. In some embodiments, the continuous-flow air-cathode iron electrocoagulation device further comprises a bisecting barrier perpendicularly disposed between the staggered anode and the air-cathode, wherein the barrier comprises at least one hole.

In some embodiments, any one of the continuous-flow air-cathode iron electrocoagulation devices described above comprises a plurality of reactor cells. In some embodiments, the device comprises from 2 to 50 reactor cells or from 10 to 20 reactor cells. In some embodiments, each reactor cell of the continuous-flow air-cathode iron electrocoagulation device comprising a plurality of reactor cells (e.g., 2 to 50, 10 to 20) is stacked on top of each other.

The embodiments and features described in the context of one of the aspects of the present invention can also apply to other aspects of the present invention. For example, embodiments and features described in the context of the methods of the present invention can also apply to the device (i.e., the continuous-flow air-cathode iron electrocoagulation device) of the present invention, and vice versa. As such, it should be understood that any and all aspects encompassed by the dependent method claims can also apply to the independent device claims (i.e., the continuous-flow air-cathode iron electrocoagulation device claims).

### BRIEF DESCRIPTION OF THE DRAWINGS

FIG. 1. Photograph of the ACAIE 60 liters per hour (LPH) device with inlets, outlets and electrode configurations. The top black surface, just below the acrylic slab with round holes, is the Air Cathode connected with the black crocodile clip to negative terminal of external voltage supply. The lower surface (not visible in the picture) is mild steel anode, connected with the red crocodile clip to positive terminal of external voltage supply.

FIG. 2. Photograph of the ACAIE 60 liters per hour (LPH) showing testing in progress.

FIG. 3. Shows a schematic of the continuous-flow ACAIE 60 L/h device.

FIG. 4. Schematic of the stack of 10 ACAIE units, of each unit having 60 LPH capacity, treating water at flow rate of 600 liters per hours continuously.

FIG. 5. Shows the influence of current density on the amount of iron released into the bulk solution for an EC device and an ACAIE device.

FIG. 6. Shows the influence of current density on the amount of iron released into the bulk solution for an EC device.

FIG. 7. Arsenic removal as a function of current density in EC and ACAIE device.

FIG. 8. Reduction in energy per order of magnitude of arsenic removed in ACAIE relative to EC.

FIG. 9. Shows schematics of antifouling ACAIE devices having a bisecting permeated barrier either disposed longitudinally between the anode and the air-cathode (AAFD-2) or disposed diagonally between the anode and the air-cathode (AAFD-2.1).

FIG. 10. Shows schematics of antifouling ACAIE devices in which the cathode and anode are laterally displaced (staggered), either without a barrier (AAFD-3) or with a bisecting barrier perpendicularly disposed between the anode and the air-cathode, in which the barrier includes at least one hole (AAFD-3.1).

FIG. 11. Decrease in H₂O₂ Faradaic efficiency of the air cathodes normalized by total hours of operation of from three distinct ACAIE design configurations.

### DETAILED DESCRIPTION OF THE INVENTION

### I. Introduction

This invention relates, in part, to a continuous-flow air-cathode iron electrocoagulation device, and use of such a device for the removal of dissolved arsenic from contaminated water using current densities of 30 mA·cm⁻² to 250 mA·cm⁻² or higher. Typically, iron electrocoagulation devices for removing arsenic from groundwater involve current densities of 0.1 mA·cm⁻² to 0.5 mA·cm⁻². Prior to the present invention, operating iron electrocoagulation devices at low current densities had been thought to be necessary in order to prevent the generation of “green rust,” which is formed at high current densities. Thus, iron electrocoagulation is limited in how rapidly iron is dissolved anodically. Coupling an air-cathode to an iron electrocoagulation device causes generation of H₂O₂ on the cathode, and blocks the formation of green rust, but current densities of 30 mA·cm⁻² to 250 mA·cm⁻² or higher have not previously been employed due to the formation of green rust, as noted above, and fouling of electrodes. The continuous-flow air-cathode iron electrocoagulation devices described herein and arsenic-removal methods employing such devices, reduce electrode fouling, which is desirable because electrode fouling decreases arsenic removal efficiency. These continuous-flow air-cathode iron electrocoagulation devices also allow for prolonged operation times.

The high current densities and continuous-flow air-cathode iron electrocoagulation device configurations reduce water treatment time, allowing for smaller reactor cell size and fewer number of cells. The devices are designed for ease of maintenance and low-cost production techniques.

### II. Definitions

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a value is close to a targeted value, where close can mean, for example, the value is within 80% of the targeted value, within 85% of the targeted value, within 90% of the targeted value, within 95% of the targeted value, or within 99% of the targeted value.

The terms “comprise,” “comprises,” and “comprising” as used herein should in general be construed as not closed—that is, as possibly including additional steps or components that are not expressly mentioned. For example, an embodiment of “a method comprising A” would include step A, but might also include B, B and C, or still other steps or components in addition to A.

As used herein, the term “continuous-flow” generally refers to an unbroken or contiguous stream of the particular material or composition that is being continuously flowed. For example, a continuous-flow of a sample includes a constant or variable fluid flow having a set velocity, or alternatively, a fluid flow which includes pauses in the flow rate of the overall device, such that the pause does not otherwise interrupt the flow stream.

As used herein, the term “current density” refers to the total current passed in an electrochemical cell divided by the geometric area of the electrodes of the cell and is commonly reported in units of mA/cm² or mA·cm⁻².

### III. Device and Methods

The present invention provides a method for removing arsenic from an aqueous solution comprising dissolved arsenic using a continuous-flow air-cathode iron electrocoagulation device having at least one reactor cell, wherein the at least one reactor cell comprises: a housing having at least one inlet, at least one outlet, at least one anode comprising iron, and at least one air-cathode, wherein inflowing aqueous solution enters the reactor cell through the at least one inlet and outflowing aqueous solution exits the reactor cell through the at least one outlet. The method comprises running a direct current through the aqueous solution via the anode and cathode at a voltage sufficient to produce a current density of from at least 30 mA·cm⁻² to about 250 mA·cm⁻², or more; and forming iron(II) species from the iron of the anode and H₂O₂ from the oxygen diffusion of the air-cathode, thereby producing insoluble iron(III) species comprising iron(III) hydroxides and arsenic-containing iron(III)-hydroxide precipitates, thereby removing arsenic from the aqueous solution. Thus, the outflowing aqueous solution has a reduction in dissolved arsenic compared to the inflowing aqueous solution. In some embodiments, the method further comprises physically removing the insoluble iron(III) species comprising iron(III) hydroxides and arsenic-containing iron(III)-hydroxide precipitates from the outflowing aqueous solution (e.g., filtering the solids from the liquid).

In some embodiments, the current density used in the methods for removing arsenic from the aqueous solution is from at least 30 mA·cm⁻² to about 400 mA·cm⁻². In some embodiments, the current density is from at least 35 mA·cm⁻² to about 350 mA·cm⁻². In some embodiments, the current density is from about 40 mA·cm⁻² to about 300 mA·cm⁻². In some embodiments, the current density is about 55 mA·cm⁻², 60 mA·cm⁻², 65 mA·cm⁻², 70 mA·cm⁻², 75 mA·cm⁻², 80 mA·cm⁻², 85 mA·cm⁻², 90 mA·cm⁻², 95 mA·cm⁻², 100 mA·cm⁻², 105 mA·cm⁻², 110 mA·cm⁻², 115 mA·cm⁻², 120 mA·cm⁻², 125 mA·cm⁻², 130 mA·cm⁻², 135 mA·cm⁻², 140 mA·cm⁻², 145 mA·cm⁻², 150 mA·cm⁻², 155 mA·cm⁻², 160 mA·cm⁻², 165 mA·cm⁻², 170 mA·cm⁻², 175 mA·cm⁻², 180 mA·cm⁻², 185 mA·cm⁻², 190 mA·cm⁻², 195 mA·cm⁻², 200 mA·cm⁻², 210 mA·cm⁻², 220 mA·cm⁻², 225 mA·cm⁻², 230 mA·cm⁻², 235 mA·cm⁻², 240 mA·cm⁻², or about 250 mA·cm⁻². In some embodiments, the current density is from about 30 mA·cm⁻² to about 250 mA·cm⁻². In some embodiments, the current density is from about 50 mA·cm⁻² to about 200 mA·cm⁻². In some embodiments, the current density is from about 60 mA·cm⁻² to about 150 mA·cm⁻². In some embodiments, the current density is from about 75 mA·cm⁻² to about 125 mA·cm⁻². In some embodiments, the current density is about 85-110 mA·cm⁻². In some embodiments, the current density is about 95-105 mA·cm⁻². In some embodiments, the current density is about 100 mA·cm⁻².

The air-cathode can be any air cathode suitable for producing H₂O₂ from O₂. Typically, the air cathode is made of a current collector on the air-facing side, a catalytic conducting layer, and a hydrophobic diffusion layer. In illustrative embodiments, the catalytic layer can be, e.g., graphite, carbon black, carbon fiber, carbon cloth, carbon paper, nitrogen-doped carbon, activated carbon, or a combination thereof. In some embodiments, the current collector can be stainless steel mesh, titanium mesh, conducting polymer mesh, or foamed nickel. The diffusion layer can contain hydrophobic binders such as polyvinylidene fluoride (PVDF), polytetrafluoroethylene (PTFE), or polydimethylsiloxane (PDMS) mixed with conducting medium such as graphite. In some embodiments, the air cathode comprises a current collector selected from stainless steel mesh, titanium mesh, conducting polymer mesh, or foamed nickel; an air facing side made of a mixture of a binder material (e.g., PTFE) mixed with graphite powder coating a base layer made of carbon fiber, carbon cloth, carbon paper, carbon nanotube, nitrogen doped carbon; and a water facing catalytic layer selected from graphite, carbon black, carbon fiber, carbon cloth, carbon paper, nitrogen doped carbon, activated carbon, or a combination thereof; and mixed with binders which can be any combination of polyvinylidene fluoride (PVDF), polytetrafluoroethylene (PTFE), or polydimethylsiloxane (PDMS).

Construction and design of air-cathodes can be found, for example, in U.S. Pat. No. 8,835,060, and Barazesh et al., Environ. Sci. Technol. 2015, 49, 7391-7399. The air-cathode can be manufactured using any method known to those of skill in the art such as for example, the rolling method, coating method, or phase inversion method. One such method is described in, for example, Barazesh et al., Environ. Sci. Technol. 2015, 49, 7391-7399.

The air-cathode can have any suitable surface area. In some embodiments, the surface area of the air-cathode is from about 1.0 cm² to about 5.0 m², about 2.0 cm² to about 1 m², or about 5.0 cm² to about 800 cm². In some embodiments, the surface area of the air-cathode is about 1.0 cm², 2.0 cm², 3.0 cm², 4.0 cm², 5.0 cm², 10.0 cm², 15.0 cm², 20.0 cm², 25.0 cm², 30.0 cm², 35.0 cm², 40.0 cm², 45.0 cm², 50.0 cm², 55.0 cm², 60.0 cm², 65.0 cm², 70.0 cm², 75.0 cm², 80.0 cm², 85.0 cm², 90.0 cm², 100 cm², 200 cm², 300 cm², 400 cm², 500 cm², 600 cm², 700 cm², 800 cm², 900 cm², 1.0 m², 2.0 m², 3.0 m², 4.0 m², or about 5.0 m². In some embodiments, surface area of the air-cathode is about 10.0 cm², 50.0 cm², 65.0 cm², 100.0 cm², 300.0 cm², 400.0 cm², or about 500.0 cm².

The anode comprising iron can be any anode suitable for producing Fe(II). In some embodiments, the iron anode comprises iron in an amount of about 70% to about 99.9% or more. In some embodiments, the iron anode comprises iron in an amount of about 70%, 75%, 80%, 85%, 90%, 91%, 92%, 93%, 94%, 95%, 97%, 98%, 98.5%, 99.0%, 99.1%, 99.2%, 99.3%, 99.4%, 99.5%, 99.6%, 99.7%, 99.8%, 99.9%, or about 99.95%. In some embodiments, the iron anode comprises iron in an amount of about 90% to about 99.9%. The anode comprising iron can be pure iron (i.e., 99.5% or more iron) or an iron-containing alloy. Representative elements that can be included in the alloy (in addition to iron) include, but are not limited to: C, Al, Mg, Zr, B, Ag, Sn, Cu, Ni, Pd, Pt, Mo, Au, Fe, Cr, Mo, Ti, Co, Mn, Zn, V, and combinations thereof. In some embodiments, the iron-containing alloy can be iron-aluminum alloy or low carbon steel (e.g., mild steel). In some embodiments, the anode comprises low carbon steel, iron-aluminum alloy, or pure iron. In some embodiments, the anode is low carbon steel having a carbon content of 6% or less.

The anode comprising iron can have any suitable surface area. In some embodiments, the surface area of the anode comprising iron is from about 1.0 cm² to about 5.0 m², about 2.0 cm² to about 1 m², or about 5.0 cm² to about 800 cm². In some embodiments, the surface area of the anode comprising iron is about 1.0 cm², 2.0 cm², 3.0 cm², 4.0 cm², 5.0 cm², 10.0 cm², 15.0 cm², 20.0 cm², 25.0 cm², 30.0 cm², 35.0 cm², 40.0 cm², 45.0 cm², 50.0 cm², 55.0 cm², 60.0 cm², 65.0 cm², 70.0 cm², 75.0 cm², 80.0 cm², 85.0 cm², 90.0 cm², 100 cm², 200 cm², 300 cm², 400 cm², 500 cm², 600 cm², 700 cm², 800 cm², 900 cm², 1.0 m², 2.0 m², 3.0 m², 4.0 m², or about 5.0 m². In some embodiments, surface area of the anode comprising iron is about 10.0 cm², 50.0 cm², 65.0 cm², 100.0 cm², 300.0 cm², 400.0 cm², or about 500.0 cm².

In some embodiments, the anode and the air-cathode of the continuous-flow air-cathode iron electrocoagulation devices and methods described herein are positioned at an inter-electrode distance of from at least 0.2 cm to about 5.0 cm. In some embodiments, the anode and the air-cathode are positioned at an inter-electrode distance of about 0.2 cm, 0.25 cm, 0.3 cm, 0.35 cm, 0.4 cm, 0.45 cm, 0.5 cm, 0.55 cm, 0.6 cm, 0.65 cm, 0.7 cm, 0.75 cm, 0.8 cm, 0.85 cm, 0.9 cm, 0.95 cm, 1.0 cm, 1.5 cm, 2.0 cm, 2.5 cm, 3.0 cm, 3.5 cm, 4.0 cm, 4.5 cm, or about 5.0 cm. In some embodiments, the anode and the air-cathode are positioned at an inter-electrode distance of from about 0.5 cm to about 3.0 cm. In some embodiments, the anode and the air-cathode are positioned at an inter-electrode distance of from about 1.0 cm to about 2.5 cm.

In some embodiments, the surface area of the anode and the surface area of the air-cathode are substantially the same size. In some embodiments, the surface area of the air-cathode is equal to between 1.0 and 0.05 times the surface area of the anode. For example, if the surface area of the anode is 5.0 cm², the surface area of the air-cathode would be between 5.0 cm² and 0.25 cm². In some embodiments, the surface area of the air-cathode is equal to between 1.0 and 0.1 times the surface area of the anode. For example, if the surface area of the anode is 5.0 cm², the surface area of the air-cathode would be between 5.0 cm² and 0.5 cm². In some embodiments, the surface area of the air-cathode is equal to between 1.0 and 0.5 times the surface area of the anode. For example, if the surface area of the anode is 5.0 cm², the surface area of the air-cathode would be between 5.0 cm² and 2.5 cm².

In some embodiments, the at least one reactor cell of the continuous-flow air-cathode iron electrocoagulation device used in the methods described herein is from at least 1.0 cm² to about 5.0 m², about 5.0 cm² to about 1 m², or about 10.0 cm² to about 1.0 m². In some embodiments, the at least one reactor cell is about 1.0 cm², 2.0 cm², 3.0 cm², 4.0 cm², 5.0 cm², 10.0 cm², 15.0 cm², 20.0 cm², 25.0 cm², 30.0 cm², 35.0 cm², 40.0 cm², 45.0 cm², 50.0 cm², 55.0 cm², 60.0 cm², 65.0 cm², 70.0 cm², 75.0 cm², 80.0 cm², 85.0 cm², 90.0 cm², 100 cm², 200 cm², 300 cm², 400 cm², 500 cm², 600 cm², 700 cm², 800 cm², 900 cm², 1.0 m², 2.0 m², 3.0 m², 4.0 m², or about 5.0 m². In some embodiments, the at least one reactor cell of the continuous-flow air-cathode iron electrocoagulation device has an anode surface area of from at least 1.0 cm² to about 5.0 m². In some embodiments, the at least one reactor cell of the continuous-flow air-cathode iron electrocoagulation device has an anode surface area of from at least 5.0 cm² to about 1.0 m². In some embodiments, the at least one reactor cell of the continuous-flow air-cathode iron electrocoagulation device used in the methods described herein has an anode surface area of from at least 10.0 cm² to about 1.0 m².

In some embodiments, the at least one reactor cell has a volume of from about 0.1 L to about 300 L, or more. In some embodiments, the at least one reactor cell has a volume of from about 0.1 L to about 200 L. In some embodiments, the at least one reactor cell has a volume of about 0.1 L, 0.2 L, 0.3 L, 0.4 L, 0.5 L, 0.6 L, 0.7 L, 0.8 L, 0.9 L, 1.0 L, 1.5 L, 2.0 L, 2.5 L, 3.0 L, 3.5 L, 4.0 L, 4.5 L, 5.0 L, 10 L, 15 L, 20 L, 25 L, 30 L, 35 L, 40 L, 50 L, 60 L, 70 L, 80 L, 90 L, 100 L, 125 L, 150 L, 175 L, or about 200 L. In some embodiments, the at least one reactor cell has a volume of from about 0.5 L to about 100 L. In some embodiments, the at least one reactor cell has a volume of from about 0.8 L to about 5.0 L. In some embodiments, the at least one reactor cell has a volume of from about 1.0 L to about 2.5 L. In some embodiments, the at least one reactor cell has a volume of from about 0.5 L to about 1.0 L.

The amount of dissolved arsenic in the aqueous solution that can be removed using the methods and continuous-flow air-cathode iron electrocoagulation device described herein can be affected by the charge dose and charge dosage rate (see, Amrose, S. et al. Journal of environmental science and health. Part A, 2013, 48, 1019-1030). In some embodiments, the charge dosage used in the methods of the instant invention is from about 1 C/L to about 5000 C/L. In some embodiments, the charge dosage used in the methods of the instant invention is from about 5 C/L to about 4000 C/L. In some embodiments, the charge dosage used in the methods of the instant invention is about 5 C/L, 10 C/L, 15 C/L, 20 C/L, 25 C/L, 30 C/L, 35 C/L, 40 C/L, 45 C/L, 50 C/L, 55 C/L, 60 C/L, 65 C/L, 70 C/L, 75 C/L, 80 C/L, 85 C/L, 90 C/L, 95 C/L, 100 C/L, 110 C/L, 120 C/L, 140 C/L, 150 C/L, 200 C/L, 250 C/L, 300 C/L, 350 C/L, 400 C/L, 450 C/L, 500 C/L, 550 C/L, 600 C/L, 650 C/L, 700 C/L, 750 C/L, 800 C/L, 850 C/L, 900 C/L, 950 C/L, 1000 C/L, 1050 C/L, 1100 C/L, 1150 C/L, 1200 C/L, 1250 C/L, 1300 C/L, 1350 C/L, 1400 C/L, 1450 C/L, 1500 C/L, 1600 C/L, 1700 C/L, 1800 C/L, 1900 C/L, 2000 C/L, 2250 C/L, 2500 C/L, 2750 C/L, 3000 C/L, 3250 C/L, 3500 C/L, 3750 C/L, or about 4000 C/L. In some embodiments, the charge dosage used in the methods of the instant invention is from about 100 C/L to about 500 C/L. In some embodiments, the charge dosage used in the methods of the instant invention is from about 150 C/L to about 350 C/L.

In some embodiments, the aqueous solution comprising dissolved arsenic continuously flows through the continuous-flow air-cathode iron electrocoagulation device at a dosage rate of from about 10 C/L/min to about 10,000 C/L/min, or more. In some embodiments, the aqueous solution continuously flows through the continuous-flow air-cathode iron electrocoagulation device at a dosage rate of from about 10 C/L/min to about 8,000 C/L/min. In some embodiments, the dosage rate is about 50 C/L/min, 60 C/L/min, 70 C/L/min, 80 C/L/min, 90 C/L/min, 100 C/L/min, 200 C/L/min, 300 C/L/min, 400 C/L/min, 500 C/L/min, 600 C/L/min, 700 C/L/min, 800 C/L/min, 900 C/L/min, 1000 C/L/min, 1250 C/L/min, 1500 C/L/min, 1750 C/L/min, 2000 C/L/min, 2250 C/L/min, 2500 C/L/min, 2750 C/L/min, 3000 C/L/min, 3250 C/L/min, 3500 C/L/min, 3750 C/L/min, 4000 C/L/min, 4250 C/L/min, 4500 C/L/min, 4750 C/L/min, 5000 C/L/min, 5250 C/L/min, 5500 C/L/min, 5750 C/L/min, 6000 C/L/min, 6250 C/L/min, 6500 C/L/min, 6750 C/L/min, 7000 C/L/min, 7250 C/L/min, 7500 C/L/min, 7750 C/L/min, or about 8000 C/L/min. In some embodiments, the dosage rate is from about 55 C/L/min to about 7000 C/L/min. In some embodiments, the dosage rate is from about 60 C/L/min to about 6000 C/L/min. In some embodiments, the dosage rate is from about 65 C/L/min to about 5000 C/L/min. In some embodiments, the dosage rate is from about 70 C/L/min to about 4000 C/L/min. In some embodiments, the dosage rate is from about 75 C/L/min to about 3000 C/L/min. In some embodiments, the dosage rate is from about 80 C/L/min to about 2000 C/L/min. In some embodiments, the dosage rate is from about 85 C/L/min to about 1000 C/L/min. In some embodiments, the dosage rate is from about 90 C/L/min to about 800 C/L/min. In some embodiments, the aqueous solution continuously flows through the continuous-flow air-cathode iron electrocoagulation device at a dosage rate of from about 100 C/L/min to about 600 C/L/min. In some embodiments, the dosage rate is about 55 C/L/min, 75 C/L/min, 95 C/L/min, 105 C/L/min, 120 C/L/min, 135 C/L/min, 235 C/L/min, 250 C/L/min, 300 C/L/min, or about 400 C/L/min.

In some embodiments, the continuous-flow air-cathode iron electrocoagulation device used in the methods described herein comprises a plurality of reactor cells. In some embodiments, the continuous-flow air-cathode iron electrocoagulation device comprises 2 to 200, or more reactor cells. In some embodiments, the continuous-flow air-cathode iron electrocoagulation device comprises 2 to 100 reactor cells. In some embodiments, the continuous-flow air-cathode iron electrocoagulation device comprises 2, 3, 4, 5, 6, 7, 8, 9, 10, 11, 12, 13, 14, 15, 16, 17, 18, 19, 20, 22, 24, 26, 28, 30, 34, 38, 40, 44, 46, 48, 50, 55, 60, 65, 70, 75, 80, 85, 90, 95 or 100 reactor cells. In some embodiments, the continuous-flow air-cathode iron electrocoagulation device comprises 2 to 50 reactor cells. In some embodiments, the continuous-flow air-cathode iron electrocoagulation device comprises 10-20 reactor cells.

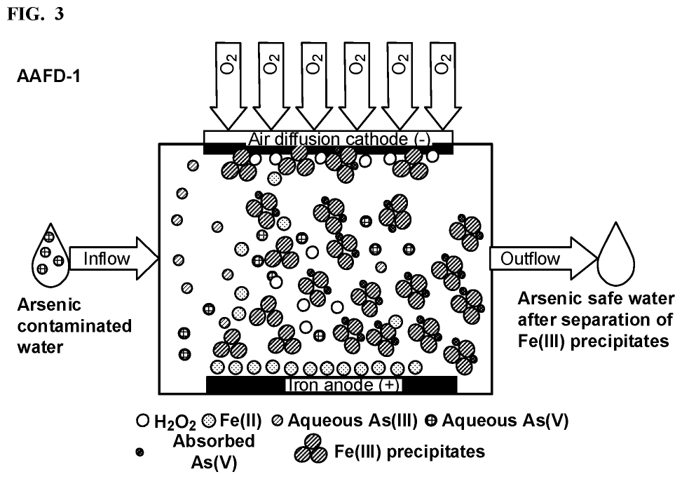

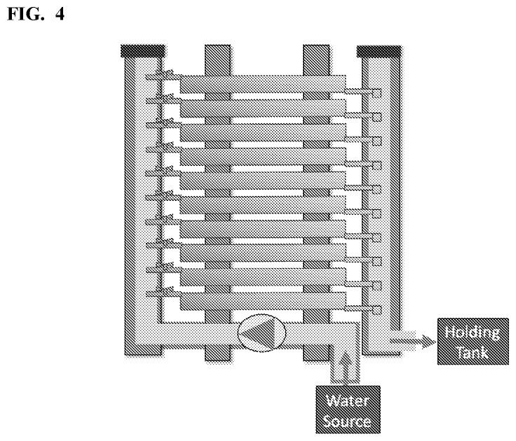

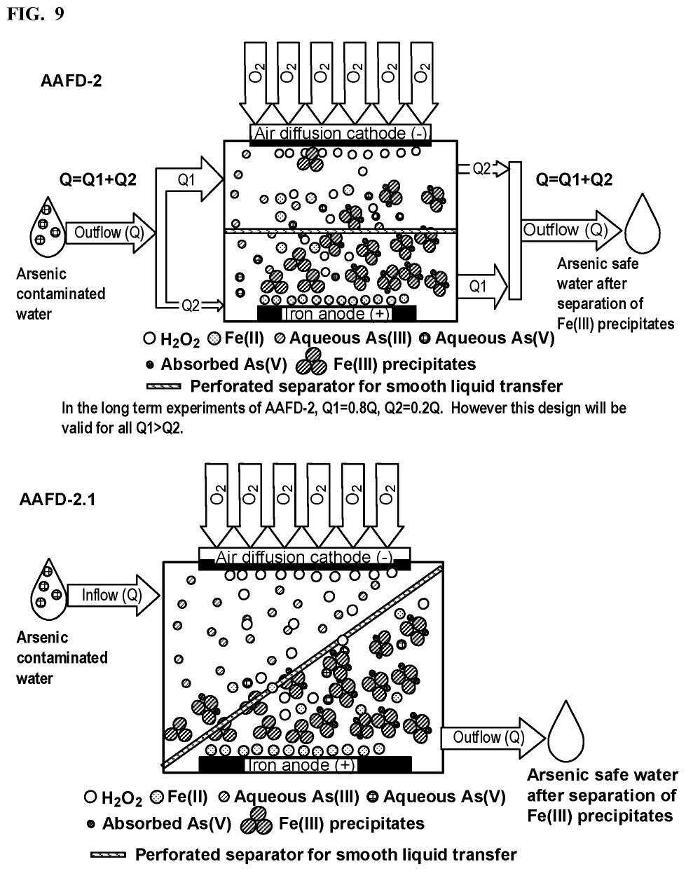

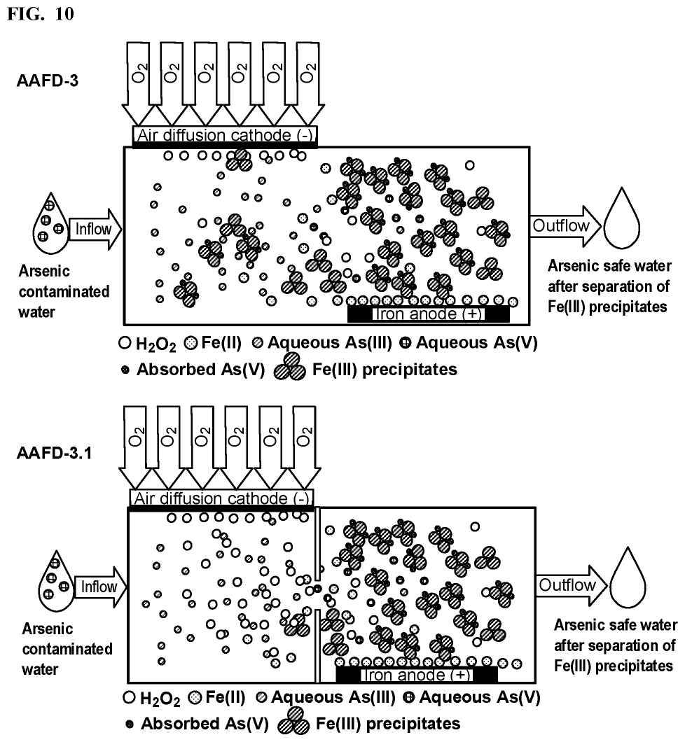

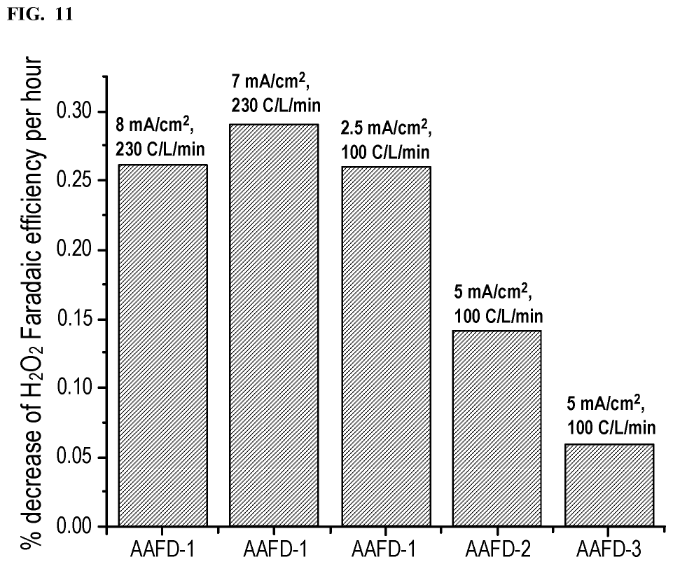

In some embodiments, each reactor cell is stacked on top of each other. For example, a 10 reactor cells having the structure and configuration of the reactor cell shown in FIG. 3, FIG. 9, and/or FIG. 10, for example, can be stacked on top of each other to form continuous-flow air-cathode iron electrocoagulation device shown in FIG. 4. In some embodiments, the distance between each reactor cell in a stack of reactor cells is from at least 2 mm to about 10 cm, or more. In some embodiments, the distance between each reactor cell in a stack of reactor cells can be about 2.5 mm, 5 mm, 10 mm, 20 mm, 40 mm, 50 mm, 100 mm, 500 mm, 750 mm, 1 cm, 2 cm, 2.5 cm, 5 cm, 6 cm, 7 cm, 8 cm, 9 cm, 10 cm, 15 cm, or about 20 cm. Each reactor cell can be laterally aligned in a stack or stacked approximately vertically for compact arrangements. Each reactor cell can be horizontally level or tilted at a suitable angle for compact arrangements, prevention of air-locking, and/or overcoming air entrainment. In some embodiments, the continuous-flow air-cathode iron electrocoagulation device comprising plurality of stacked reactor cells can also include an external blowers or fans to improve fresh air circulation to the air-cathode surfaces of each cell in the stack, since air-cathodes consume oxygen from air.

The method for removing arsenic from an aqueous solution comprising dissolved arsenic involving a continuous-flow air-cathode iron electrocoagulation device described herein produces an outflowing aqueous solution having a reduced amount of dissolved arsenic compared to the inflowing aqueous solution. Using the methods of the instant invention, the reduced amount of dissolved arsenic in the outflowing aqueous solution is less than 10 ppb, less than 8 ppb, less than 5 ppb, less than 3.5 ppb, or less than 1.5 ppb. In some embodiments, the outflowing aqueous solution has a reduction in dissolved arsenic of at least 75% compared to the inflowing aqueous solution. In some embodiments, the outflowing aqueous solution has a reduction in dissolved arsenic of at least 85% compared to the inflowing aqueous solution. In some embodiments, the outflowing aqueous solution has a reduction in dissolved arsenic of at least 95% compared to the inflowing aqueous solution. In some embodiments, the outflowing aqueous solution has a reduction in dissolved arsenic of at least 98% compared to the inflowing aqueous solution.

In some embodiments, the at least one reactor cell of the continuous-flow air-cathode electrocoagulation device used in the methods described herein further comprises a bisecting perforated barrier disposed between the anode and the air-cathode. In some embodiments, the bisecting perforated barrier is disposed longitudinally between the anode and the air-cathode. In some embodiments, the bisecting perforated barrier is disposed diagonally between the anode and the air-cathode. In some embodiments, the aqueous solution enters the at least one reactor cell through the at least one inlet and flows across the perforated barrier. In some embodiments, the inlet water first encounters the air-cathode, then passes through the perforated barrier, and only then encounters the iron anode. In some embodiments, the perforated barrier is made of non-conducting material (e.g., plastic, e.g., polycarbonate). In some embodiments, the perforated barrier is made of conducting material (e.g., Titanium). The thickness of the barrier depends on the mechanical stiffness of the material; the thickness is selected for convenience such that the barrier holds its shape. In some embodiments, the perforations in the barrier are sized so that their cumulative area exceeds the area of the at least one inlet by 5%, 10%, 50%, 100%, 200%, 500%, 750%, 1000%, 1500%, 2000%, etc. In some embodiments, the perforation area exceeds the area of the at least one inlet by 20%. In some embodiments the perforations are uniformly distributed throughout the barrier. In some embodiments the perforations are non-uniformly distributed throughout the barrier. The perforated barrier can placed such that there is no bypass for inlet fluid flow around the edges of the barrier. The perforation size is such that each perforation has a minimum hydraulic diameter of 0.5 mm and a maximum hydraulic diameter of 2.0 cm. The perforated barrier bisects the reactor cell between the cathode and the anode, fully separating the air-cathode in a first compartment and the anode in a second compartment. The at least one inlet is placed such that all or a majority of the inflowing water enters the first compartment containing the air-cathode formed by the perforated barrier.

In some embodiments, the anode and the air-cathode of the reactor cell can be in a staggered position relative to each other, wherein the cathode and anode are laterally staggered with respect to each other. In some embodiments, the air-cathode is placed such that all of it is positioned entirely upstream of the anode, wherein upstream is defined according to the streamlines of the fluid flow in the cell.

In some embodiments, the at least one reactor cell of the continuous-flow air-cathode electrocoagulation device comprising an anode and an air-cathode in a staggered position can further comprise a bisecting barrier perpendicularly disposed between the staggered anode and air-cathode, wherein the barrier comprises at least one hole. In some embodiments, the barrier is a perforated barrier. In some embodiments, the perforated barrier is made of non-conducting material (e.g., plastic, e.g., polycarbonate). The thickness of the barrier depends on the mechanical stiffness of the material; the thickness is selected for convenience such that the barrier holds its shape. In some embodiments, the perforations in the barrier are sized so that their cumulative area exceeds the area of the at least one inlet by 5%, 10%, 50%, 100%, 200%, 500%, 750%, 1000%, 1500%, 2000%, etc. In some embodiments, the perforation area exceeds the area of the at least one inlet by 20%. In some embodiments the perforations are uniformly distributed throughout the barrier. In some embodiments the perforations are non-uniformly distributed throughout the barrier.

In some embodiments, aqueous solutions can continuously flow through the continuous-flow air-cathode iron electrocoagulation device used in the methods described herein for a certain period of time. In some embodiments, the aqueous solution continuously flows through the continuous-flow air-cathode iron electrocoagulation device for about 40 hours to about 1000 hours. In some embodiments, the aqueous solution continuously flows through the continuous-flow air-cathode iron electrocoagulation device for about 40 hours, 50 hours, 60 hours, 70 hours, 80 hours, 90 hours, 100 hours, 120 hours, 130 hours, 140 hours, 150 hours, 160 hours, 170 hours, 180 hours, 190 hours, 200 hours, 210 hours, 250 hours, 300 hours, 400 hours, 500 hours, 600 hours, 700 hours, 800 hours, 900 hours, or about 1000 hours. In some embodiments, the aqueous solution continuously flows through the continuous-flow air-cathode iron electrocoagulation device for about 90 hours to about 500 hours. In some embodiments, the aqueous solution continuously flows through the continuous-flow air-cathode iron electrocoagulation device for about 90 hours to about 216 hours. In certain embodiments, the aqueous solution continuously flows through the continuous-flow air-cathode iron electrocoagulation device using a current density of from at least 30 mA·cm⁻² to about 250 mA·cm⁻² for over 40 hours, 50 hours, 60 hours, 70 hours, 80 hours, 90 hours, 100 hours, 120 hours, 130 hours, 140 hours, 150 hours, 160 hours, 170 hours, 180 hours, 190 hours, 200 hours, 210 hours, 215 hours, 220 hours, 225 hours, 250 hours, 300 hours, or more.

In some embodiments, the continuous-flow air-cathode iron electrocoagulation device used in the methods described herein can maintain a certain percentage of the initial faradaic efficiency of H₂O₂ production after a period of time of continuous flow. In some embodiments, the continuous-flow air-cathode iron electrocoagulation device can maintain at least about 30% faradaic efficiency of H₂O₂ production after at least about 50 hours of continuous flow. In some embodiments, the continuous-flow air-cathode iron electrocoagulation device can maintain at least about 50% faradaic efficiency of H₂O₂ production after at least about 50 hours of continuous flow. In some embodiments, the continuous-flow air-cathode iron electrocoagulation device can maintain at least about 50% faradaic efficiency of H₂O₂ production after at least about 90 hours of continuous flow. In some embodiments, the continuous-flow air-cathode iron electrocoagulation device can maintain at least about 50% faradaic efficiency of H₂O₂ production after at least about 100 hours of continuous flow. In some embodiments, the continuous-flow air-cathode iron electrocoagulation device used in the methods described herein can maintain a certain percentage of the initial faradaic efficiency of H₂O₂ production after a period of time of continuous flow using a current density of from at least 30 mA·cm⁻² to about 250 mA·cm⁻². In certain embodiments, after about 50 hours of continuous flow, the continuous-flow air-cathode iron electrocoagulation device can maintain a percent of the initial faradaic efficiency of H₂O₂ production of at least about 10%, or at least about 20, 30, 40, 50, 60, 70, 80, or 90%.

The flow rates in the device can be characterized in terms of residence time of water in the device. For the applications described here, the residence time of a water-parcel in the device can range from a minimum of 0.5 second to a maximum of 300 seconds.

In some embodiments, the continuous-flow air-cathode iron electrocoagulation device comprises at least one reactor cell, wherein the at least one reactor cell comprises: a housing having at least one inlet for an aqueous solution comprising an amount of dissolved arsenic and at least one outlet for the aqueous solution having a reduced amount of dissolved arsenic; at least one air-cathode disposed within the housing and at least one anode comprising iron disposed within the housing, wherein the cathode and anode are laterally aligned with respect to each other and disposed on opposing sides of the housing; a bisecting perforated barrier disposed within the house between the cathode and anode, wherein the bisecting perforated barrier reduces contact between the cathode and insoluble iron(III) species comprising iron(III) hydroxides and arsenic-containing iron(III)-hydroxide precipitates; and a direct power source; and wherein the at least one inlet allows for flow of the aqueous solution comprising an amount of dissolved arsenic across the perforated barrier.

In some embodiments, the continuous-flow air-cathode iron electrocoagulation device having at least one reactor cell, wherein the at least one reactor cell comprises: a housing having at least one inlet for an aqueous solution comprising an amount of dissolved arsenic and at least one outlet for the aqueous solution having a reduced amount of dissolved arsenic; at least one air-cathode disposed within the housing and at least one anode comprising iron disposed within the housing, wherein the cathode and anode are laterally staggered with respect to each other and disposed on opposing sides of the housing; a direct power source; and wherein the lateral staggering of the cathode and anode reduces contact between the cathode and insoluble iron(III) species comprising iron(III) hydroxides and arsenic-containing iron(III)-hydroxide precipitates.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

### IV. Examples

The following examples are provided by way of illustration only and not by way of limitation. Those of skill will readily recognize a variety of noncritical parameters which could be changed or modified to yield essentially similar results.

### Materials and Methods

Experiments using an electrocoagulation (EC) device involved an EC cell consisting of two rectangular low carbon steel electrodes spaced at 2.5 cm. Experiments were designed and performed at different current densities (0.5 mA·cm⁻², 10 mA·cm⁻², and 100 mA·cm⁻²). The submerged electrode surface area was 53 cm² when using current densities of 0.5 mA·cm⁻² and 10 mA·cm⁻². When using a current density of 100 mA·cm⁻², the submerged electrode surface area was 10 cm². Prior to the first experiment, each electrode was polished with fine grained sandpaper and rinsed with DI water. No further cleaning of the electrodes was conducted after the first experiment. All experiments were conducted in a 0.5 L solutions open to the atmosphere at room temperature. The solutions were stirred with a magnetic stir bar at 600 rpm.

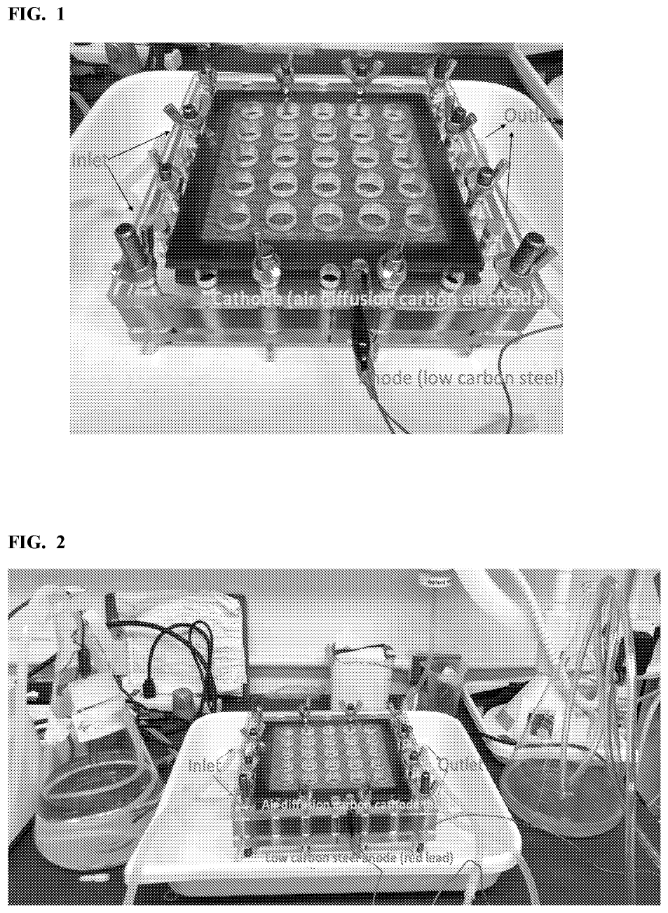

Experiments using the air-cathode assisted iron electrocoagulation (ACAIE) device involved an ACAIE cell consisting of two rectangular shaped electrodes housed in a rectangular box having an active volume of 0.5 L. Low carbon steel (purchased from McMaster-Carr, part number 6544K13, iron content: >98%) was used as an anode. The submerged anode surface area was 53 cm² when using current densities of 0.5 mA·cm⁻² and 10 mA·cm⁻², and 10 cm² when using a current density of 100 mA·cm⁻². An air diffusion carbon electrode was used as the cathode, which was prepared according to the methods described in Barazesh et al., Environ. Sci. Technol. 2015, 49, 7391-7399. The submerged cathode surface area was 64 cm² when using current densities of 0.5 mA·cm⁻² and 10 mA·cm⁻², and 10 cm² when using a current density of 100 mA·cm⁻². As seen in FIG. 1, the “top” surface of the cell comprises the air-cathode supported by a sheet of transparent acrylic (reactor cell housing) with large circular holes on its exterior surface. The holes on the acrylic housing allow air access to the air-cathode.

Synthetic Bangladesh Ground Water (SBGW) was prepared in 20 L batches following the published procedures to represent the arsenic contaminated groundwater in South Asia (Roberts et. al, 2004). Stock solutions of 0.2 M NaHCO₃, 0.1 M CaCl₂, 0.1M MgCl₂, 0.02M Na₂SiO₃, 0.1M Na₂HPO₄ and 0.05M As(III) were used to make SBGW. Each batch of 20 L SBGW was prepared by adding desired volumes of NaHCO₃, MgCl₂, Na₂HPO₄ and As(III) to deionized (DI) water. Following these additions, CO₂(g) was bubbled to bring the solution pH to 6.5-7.0 and then desired amounts of CaCl₂, Na₂SiO₃ was added under vigorous stirring. The final concentrations of SBGW were 8.2 mM of NaHCO₃, 2.5 mM Ca²⁺, 1.6 mM Mg²⁺, 0.1 mM Phosphate (P), 1 mM Silicate (Si) and 1500 μg/L As(III). The initial pH of the experiments was adjusted to 7.0 by exsolving the CO_{2(g)} under constant stirring, adding μL of 1.1M HCl, or 1M NaOH. The initial and final values of pH, Dissolved Oxygen (DO) and conductivity were measured using a Thermo Scientific Orion 5 Star.

Experiments in both EC and ACAIE cells were initiated by applying constant DC current to the electrodes submerged in the solution using a benchtop DC power supplies (Keysight Technologies, N5750A and E36104A) equipped with voltmeter and ammeter. A reference electrode (Ag/AgCl, double junction 3M KCl) was placed between the two electrodes to measure the interface potentials with respect to anode and cathode. A total coulombic dose (i.e., charge dose) of 300 C/L (88 mg/L Fe) was used in all the experiments. A DC current of 26, 525 and 1000 mA was applied for durations of 95, 5 and 2.5 mins, respectively, to deliver the same coulombic dose (300 C/L) in all experiments. Thus, the respective dosage rates at the three current densities of 0.5, 10, 100 mA·cm⁻² were 3, 63 and 120 C/L/min respectively. These parameters were selected to represent wide range of operating conditions in the field. At the end of each experiment, a wide mouth pipette was used to obtain 10 ml aliquots of the final suspension for total iron concentrations. To obtain the dissolved concentrations of the constituents, additional 10 ml of the aliquots were filtered using 0.45 μm Nylon syringe filter. All samples were acidified immediately after collection using 1.1N HCl.

The comparative EC and ACAIE experiments were conducted in batch mode for convenience to test and prove the concepts of the instant invention. All batch mode experiments and results thereof are translatable to the continuous-flow ACAIE devices and can be implemented in the field. The continuous-flow ACAIE device involves rectangular parallelepiped reactor having an active volume of 1 L connected by peristaltic pump to one or more influent ports, and has tubing connected to one or more (a plurality of) effluent ports. This experimental reactor cell was built within an acrylic housing. The active surface area of each electrode used in this device was 400 cm². The inlet and outlet of this device are shown in the FIGS. 1, 2, and 3). The device was designed to successfully treat 60 L/h of contaminated water in a continuous-flow mode. The colorless solution (FIG. 2, near inlet, on far left) is the influent solution, which becomes orange in color after treatment in the continuous-flow ACAIE device due to the formation of orange Fe(III) precipitates. The treated solution is stored in the flask on the right (near outlet). Multiple continuous-flow ACAIE reactor cells of FIGS. 1, 2, and 3 can be oriented in a stacked configuration to increase water treatment efficiency (FIG. 4). As shown in FIG. 4, a stack of 10 ACAIE reactor cell units, in which each individual unit has a 60 L/h capacity, can treat arsenic contaminated water at a flow rate of 600 L/h continuously. The number of units in each stack can be decreased or increased, depending volume of water that needs to be treated, and multiple stacks can be arranged in parallel in banks of stacks for treating much high flow rates.

### The Effect of Current Density on Total Iron Production

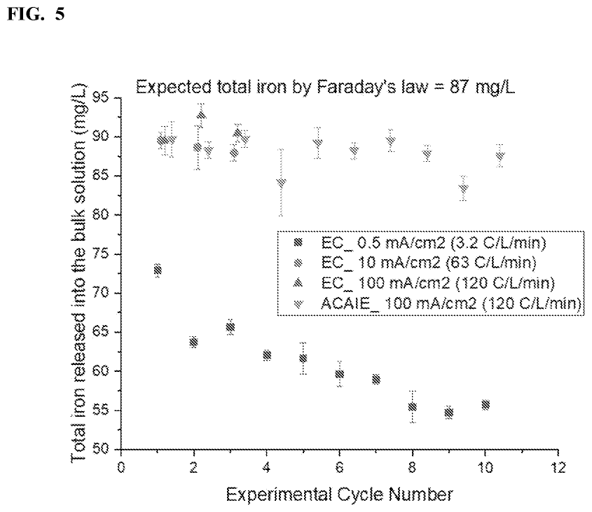

Current density has great influence on the amount of iron released from anodic dissolution and transported into the bulk solution. This effect is highly pronounced when the device was operated over the long term, and long term operation is essential for successful performance in the field. Long term production of total iron as a function of current density in EC and ACAIE device is shown in FIG. 5 (total Fe dose=300 C/L; electrolyte: SBGW; pH 7). The horizontal axis is denoted in “cycle numbers” whose actual duration differs widely, in inverse proportion as the charge dosage rate (shown in the text box within the figure in units of C/L/min). Highest charge dosage rate of 120 C/L/min has cycles of the shortest duration of 2.5 minutes. The cycle duration of the charge dosage rates of 3.2 C/L/min and 120 C/L/min are 94 minutes and 2.4 minutes, respectively.

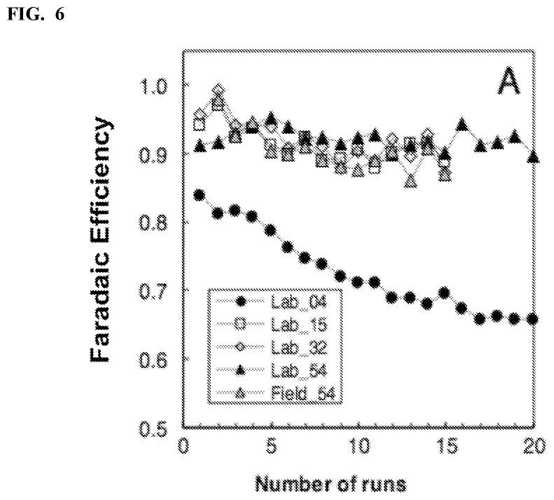

FIG. 6 shows Faradaic efficiency (total iron released into the bulk solution/total iron expected by Faraday's law) as a function of number of runs or cycle numbers for EC experiments performed at charge dosage rates 4, 15, 32, 54 C/L/mins, respectively. The corresponding current densities are 0.8, 2.8, 6.0, 10 mA·cm⁻² respectively. Lab_54 and Field_54 experiments were performed at dosage rates 54 C/L/min using varying purity of carbon steel. Total Fe dose in these experiments was at 430 C/L (electrolyte: SBGW; pH 7).

At the low current densities (0.5 mA·cm⁻²) studied in experiment data reported in FIG. 5 and FIG. 6, the amount of iron released into the bulk solution steadily decreased with time in EC devices. This decline could be due to “passivation” of the anode surface (FIG. 5), i.e., buildup of thicker and thicker layers of solid rust on anode surfaces, increasingly preventing release of iron into the bulk solution. The data showing the amount of iron released into the bulk solution at current densities 0.5 mA·cm⁻² (FIG. 5) and 0.8 mA·cm⁻² (FIG. 6) clearly indicate increasing “passivation” of the anode surface. At higher current densities (FIG. 5, EC_100 mA·cm⁻², ACAIE_100 mA·cm⁻²), the amount of iron released into the bulk solution is constant over the long term cycle numbers in both EC and ACAIE devices. This is further supported in FIG. 6, where the faradaic efficiency (measured amount of iron released into the bulk solution/total iron lost from the anode as expected by faraday's law) of anodic dissolution remains above 90% with increasing time over much longer cycle numbers.

### The Effect of Current Density on Arsenic Removal

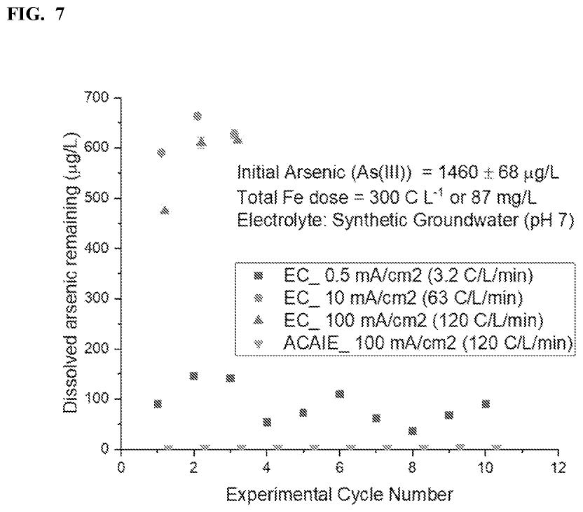

Arsenic exists in two oxidation states in nature: As(III) and As(V). The As(III) is harder to remove because it exists in nonionic form at near neutral pH and hence it commonly must be first oxidized to As(V), which is then easily removed through sorption. Therefore, we used As(III) in our synthetic groundwater composition to represent the worst case conditions for arsenic removal in EC and ACAIE experiments. FIG. 7 shows the total arsenic removal at current densities 0.5, 10, 100 mA·cm⁻² in EC and at current density 100 mA·cm⁻² ACAIE devices (total Fe dose=300 C/L; electrolyte: SBGW; pH 7. The horizontal axis is denoted in “cycle numbers” whose actual duration differs widely, in inverse proportion as the charge dosage rate. Highest charge dosage rate of 120 C/L/min has cycles of the shortest duration, of 2.5 minutes. The cycle duration for charge dosage rates of 63 C/L/min and 3.2 C/L/min were 4.8 minutes and 94 minutes respectively. In ACAIE device, the arsenic concentration was decreased from its initial value of 1460±68 μg/L to less than 5 μg/L at 100 mA·cm⁻², whereas the arsenic concentrations in EC device at current densities (10 mA·cm⁻², 100 mA·cm⁻²) were significantly higher than the arsenic maximum contaminant level (MCL) of 10 μg/L recommended by World Health Organization (WHO). Arsenic removal in ACAIE device at 100 mA·cm⁻² (120 C/L/min, 2.5 minutes experiment duration) outcompetes the performance of EC device at low current density (3.2 C/L/min, experiment duration of 94 minutes).

Excellent arsenic removal was observed using the ACAIE device at high current densities (e.g., 100 mA·cm⁻²) due to efficient, fast oxidation of As(III) by the fenton type oxidants generate during the reaction between anodically generated Fe(II) and cathodically produced H₂O₂. The fast oxidation kinetics of Fe(II) by H₂O₂ ensure complete oxidation of As(III) to As(V) in the solution. As(V) rapidly adsorbs onto Fe(III) precipitates and is thus removed from the bulk solution.

Very rapid arsenic removal was observed due to high current densities in the ACAIE devices as described in above paragraphs. However, consumption of electrical energy used for electrolysis is also an important consideration in the trade-off between savings of time, and savings of electrical energy. Electrical energy consumption in the removal of arsenic is commonly measured in the literature using a metric E_{EO}. E_{EO} is defined by the following equation:

$${E}_{E O} = \frac{V * I * t}{Volume * lo g ( \frac{{C}_{0}}{C} )}$$

where ‘V’ is the total cell potential (V), ‘I’ is the total current (A), ‘t’ is the electrolysis time (h), ‘Volume’ is the total volume of aqueous solution being treated during electrolysis (m³), ‘Co’ is the initial total dissolved arsenic concentration (ppb) and ‘C’ is the total dissolved arsenic concentration (ppb) at time ‘t’. The units of E_{EO} were kWh/(m3·log) (Barazesh et al 2015).

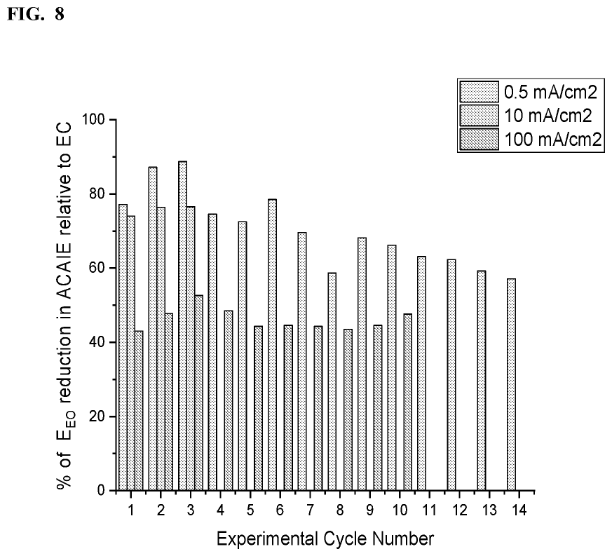

FIG. 8 shows experimental data comparing E_{EO} for several operating parameters and designs of ACAIE with E_{EO} of normal standard EC. The vertical axis reports reduction in E_{EO} (in percent terms) relative of an EC unit operated under identical parametric conditions. As the figure shows, with increasing current density, time-savings (in terms of increased volumetric throughput of water treated) increase substantially because time-savings are directly related to current density.

### Fouling of Air-Cathodes During Long Term Operation

In ACAIE devices, the liquid facing side of the air cathode is exposed to the Fe(III) precipitates formed in bulk solution (see, FIG. 3). When an ACAIE device is operated over long periods of time, progressively increasing deposits of Fe(III) precipitates on the air-cathode can reduce its efficiency of H₂O₂ generation, and thus decrease the performance of ACAIE device.

Continuous flow ACAIE experiments were conducted for long durations to understand the performance of air cathode when operated at conditions similar to the field devices. The duration of these experiments ranges from 90 to 216 hours of operation in continuous flow mode. The extent of air cathodes fouling was measured by comparing the faradaic efficiency of H₂O₂ generation from fresh air cathode at the start of experiments, with that from fouled air cathode at the end of experiments.

Table 1 below shows various operating conditions used during the long term testing of three distinct designs of ACAIE devices (FIGS. 3, 9 and 10). AAFD-1 (FIG. 3) is the ACAIE device without any mechanisms to minimize fouling of the air cathodes. AAFD-2 (FIG. 9) is an ACAIE device in which the inlet flow was manipulated to prevent the accumulation of Fe(III) precipitates on the air cathode. AAFD-3 (FIG. 10) is an ACAIE device in which the air cathode and iron anode were displaced laterally (i.e., staggered) so that inlet water enters near the cathode and exits near the iron anode. The liquid flow configurations minimize the accumulation of Fe(III) precipitates on the air cathode.

TABLE 1
Summary of the longterm testing of the ACAIE Antifouling designs (AAFD)

| | | | | | Faradaic efficiency | | Decrease | % decrease |
|---|---|---|---|---|---|---|---|---|
| | | | | Total | (%) of H₂O₂ | | in H₂O₂ | of H₂O₂ |
| ACAIE | Current | Dosage | Flow | operation | generation | | Faradaic | Faradaic |
| design | density | rate | rate | time | Fresh | Fouled | efficiency | efficiency |
| types | (mA/cm²) | (C/L/min) | (ml/min) | (Hours) | cathode | cathode | (%) | per hour |
| AAFD-1 | 8 | 230 | 78 | 90 | 71 | 48 | 23 | 0.26 |
| AAFD-1 | 7 | 250 | 105 | 105 | 85 | 54 | 31 | 0.29 |
| AAFD-1 | 2.5 | 100 | 150 | 216 | 80 | 25 | 55 | 0.26 |
| AAFD-2 | 5 | 100 | 300 | 216 | 89 | 60 | 30 | 0.14 |
| AAFD-3 | 5 | 100 | 300 | 216 | 78 | 65 | 13 | 0.06 |

AAFD-1: Basic design,
AAFD-2: Crossflow design,
AAFD-3: Staggered design

As shown in FIG. 11, AAFD-2 and AAFD-3 ACAIE devices were designed to minimize the rate of fouling as shown by the data. Total hours of operation of these devices ranges from 90 to 216 hours in continuous flow mode. The minimized rate of fouling using the AAFD-2 and AAFD-3 devices for long periods of operation time (e.g., 90 to 216 hours, or more) will also occur with current densities of 30 mA·cm⁻² to 250 mA·cm⁻² or more.

### Summary

Current densities of less than about 1 mA·cm⁻² lead to passivation (i.e., fouling) of iron anodes, as is observed in both EC and ACAIE. Passivation causes steady decline in the amount of iron released in the bulk solution relative to the rate of iron dissolution demanded by Faraday's law. Release of iron in the bulk solution is essential first step for removal of dissolved arsenic with EC and ACAIE.

High current densities overcome this passivation of anode, as demonstrated in our experiments. These high current densities can shorten the treatment cycle from the typical ˜90 minutes to as short as ˜2 minutes in a given reactor volume. High current densities are accompanied by proportionally high release rates of anodically dissolved iron.

High release rate of dissolved iron in the bulk solution requires its rapid oxidation, and air-cathodes are able to provide that oxidation in ACAIE.

However, long term operation (over many hundreds of hours) is essential for successful field operation, and air cathodes are observed to foul rapidly (at about 0.3% per hour of operation in our set up). This causes decline of ˜60% in air-cathode performance in 200 hours. This is will cause failure of air-cathode in long term operation.

Manipulation of hydraulics of the ACAIE flow-cell, by causing the entering bulk solution to first encounter only the air-cathode, and only then encounter the dissolving iron anode, can reduce the fouling rates of the air-cathode very substantially. We demonstrated a reduction in fouling rate (from baseline of 0.25% per hour) to 0.06% per hour, a factor of about 4×, using such designs (e.g., AAFD-2 and AAFD-3).

1. A method for removing arsenic from an aqueous solution comprising dissolved arsenic, the method comprising:
flowing the aqueous solution through a continuous-flow air-cathode iron electrocoagulation device having at least one reactor cell, wherein the at least one reactor cell comprises: a housing having at least one inlet, at least one outlet, at least one anode comprising iron, and at least one air-cathode, wherein inflowing aqueous solution enters the reactor cell through the at least one inlet and outflowing aqueous solution exits the reactor cell through the at least one outlet;
running a direct current through the aqueous solution via the anode and cathode at a voltage sufficient to produce a current density of from at least 30 mA·cm⁻² to about 250 mA·cm⁻²; and
forming iron(II) species from the iron of the anode and forming H₂O₂ from the oxygen diffusion of the air-cathode, thereby producing insoluble iron(III) species comprising iron(III) hydroxides and arsenic-containing iron(III)-hydroxide precipitates, thereby removing arsenic from the aqueous solution, wherein the outflowing aqueous solution has a reduction in dissolved arsenic compared to the inflowing aqueous solution.

2. The method of claim 1, further comprising physically removing the insoluble iron(III) species comprising iron(III) hydroxides and arsenic-containing iron(III)-hydroxide precipitates from the outflowing aqueous solution.

3. The method of claim 1, wherein the current density is from about 50 mA·cm⁻² to about 200 mA·cm⁻².

4.-6. (canceled)

7. The method of claim 1, wherein the anode comprises iron in an amount of from about 80% to about 99.9%; or the anode comprises low carbon steel, iron-aluminum alloy, or pure iron.

8. (canceled)

9. The method of claim 1, wherein the air-cathode comprises:
a current collector selected from stainless steel mesh, titanium mesh, conducting polymer mesh, or foamed nickel;
a catalytic layer selected from graphite, carbon black, carbon fiber, carbon cloth, carbon paper, nitrogen-doped carbon, activated carbon, or a combination thereof; and
a diffusion layer selected from polyvinylidene fluoride (PVDF), polytetrafluoroethylene (PTFE), or polydimethylsiloxane (PDMS).

10. The method of claim 1, wherein the anode and the air-cathode are positioned at an inter-electrode distance of from at least 0.2 cm to about 5.0 cm.

11.-12. (canceled)

13. The method of claim 1, wherein the anode and the air-cathode have surface areas of from about 1.0 cm² to about 5.0 m², or from about 5.0 cm² to about 800 cm².

14. (canceled)

15. The method of claim 1, wherein the at least one reactor cell of the continuous-flow air-cathode iron electrocoagulation device is from at least about 1.0 cm² to about 5.0 m².

16.-17. (canceled)

18. The method of claim 1, wherein the at least one reactor cell of the continuous-flow air-cathode iron electrocoagulation device (i) has an anode surface area of from at least about 1.0 cm² to about 5.0 m²; from at least about 5.0 cm² to about 1.0 m²; or from at least about 10.0 cm² to about 1.0 m²; and/or (ii) the surface area of air-cathode is equal to between 1.0 and 0.05 times the area of the anode; the surface area of air-cathode is equal to between 1.0 and 0.1 times the area of the anode; or the surface area of air-cathode is equal to between 1 and 0.5 times the area of the anode.

19. The method of claim 1, wherein the at least one reactor cell has a volume of from about 0.1 L to about 200 L.

20.-22. (canceled)

23. The method of claim 1, wherein the continuous-flow air-cathode iron electrocoagulation device comprises a plurality of reactor cells, optionally wherein each reactor cell is stacked on top of each other.

24.-26. (canceled)

27. The method of claim 1, wherein the outflowing aqueous solution has a reduction in dissolved arsenic of at least 95% compared to the inflowing aqueous solution.

28. The method of claim 1, wherein the aqueous solution continuously flows through the continuous-flow air-cathode iron electrocoagulation device at a dosage rate of from about 50 C/L/min to about 8000 C/L/min.

29. (canceled)

30. The method of claim 1, wherein the at least one reactor cell of the continuous-flow air-cathode electrocoagulation device further comprises a bisecting perforated barrier disposed between the anode and the air-cathode, optionally wherein the bisecting perforated barrier is disposed longitudinally between the anode and the air-cathode or is disposed diagonally between the anode and the air-cathode; or the bisecting barrier perpendicularly disposed between the anode and the air-cathode, wherein the barrier comprises at least one hole.

31.-32. (canceled)

33. The method of claim 30, wherein the aqueous solution enters the at least one reactor cell through the at least one inlet and flows across the perforated barrier.

34. The method of claim 1, wherein the at least one anode and the at least one air-cathode are in a staggered position relative to each other, optionally wherein the at least one reactor cell of the continuous flow air cathode electrocoagulation device further comprises a bisecting barrier perpendicularly disposed between the anode and the air-cathode, wherein the barrier comprises at least one hole.

35. (canceled)

36. The method of claim 1, wherein the aqueous solution flows through the continuous-flow air-cathode iron electrocoagulation device for about 40 hours to about 1000 hours.

37. (canceled)

38. The method of claim 36, wherein the continuous-flow air-cathode iron electrocoagulation device maintains at least 50% faradaic efficiency of H₂O₂ production after at least about 50 hours of continuous flow.

39. A continuous-flow air-cathode iron electrocoagulation device having at least one reactor cell, wherein the at least one reactor cell comprises:
a housing having at least one inlet for an aqueous solution comprising an amount of dissolved arsenic and at least one outlet for the aqueous solution having a reduced amount of dissolved arsenic;
at least one air-cathode disposed within the housing and at least one anode comprising iron disposed within the housing, wherein the cathode and anode are laterally aligned with respect to each other and disposed on opposing sides of the housing;
a bisecting perforated barrier disposed within the housing between the cathode and anode, wherein the bisecting perforated barrier reduces contact between the cathode and insoluble iron(III) species comprising iron(III) hydroxides and arsenic-containing iron(III)-hydroxide precipitates; and
a direct power source; and
wherein the at least one inlet allows for flow of the aqueous solution comprising an amount of dissolved arsenic across the perforated barrier; and
optionally wherein the bisecting perforated barrier is disposed longitudinally between the anode and the air-cathode, or wherein the bisecting perforated barrier is disposed diagonally between the anode and the air-cathode.

40-41. (canceled)

42. A continuous-flow air-cathode iron electrocoagulation device having at least one reactor cell, wherein the at least one reactor cell comprises:
a housing having at least one inlet for an aqueous solution comprising an amount of dissolved arsenic and at least one outlet for the aqueous solution having a reduced amount of dissolved arsenic;
at least one air-cathode disposed within the housing and at least one anode comprising iron disposed within the housing, wherein the cathode and anode are laterally staggered with respect to each other and disposed on opposing sides of the housing;
a direct power source; and
wherein the lateral staggering of the cathode and anode reduces contact between the cathode and insoluble iron(III) species comprising iron(III) hydroxides and arsenic-containing iron(III)-hydroxide precipitates.

43.-47. (canceled)
